(19) United States
(12) Patent Application Publication
(10) Pub. No.: US 2003/0018581 A1
(43) Pub. Date: Jan. 23, 2003

(54) Delivering media data to portable computing devices

(76) Inventors: Timothy R. Bratton, Los Altos, CA (US); Sylvain Rebaud, San Francisco, CA (US); J. P. Lester, San Francisco, CA (US); Mauricio Greene, Paris (FR)

Correspondence Address: FENWICK & WEST LLP, TWO PALO ALTO SQUARE, PALO ALTO, CA, 94306, US

(21) Appl. No.: 10/046,933

(22) Filed: Oct. 26, 2001

Related U.S. Application Data
(63) Continuation-in-part of application No. 09/505,486, filed on Feb. 16, 2000.
(60) Provisional application No. 60/244,059, filed on Oct. 27, 2000.

(51) Int. Cl. G06F 17/60

(52) U.S. Cl. 705/50

(57) ABSTRACT

Power consumption in a portable computing device's receive-transmit subsystem is reduced when this subsystem receives streaming media data. The portable computing device receives a first portion of the media data via a first communication channel and a second portion of the media data via a second channel. The portable computing device may obtain the first portion well in advance of receiving the second portion and may use a wireless connection to receive the second portion. The portable computing device may terminate the wireless connection once the second portion has been received, thus reducing overall power consumption in wireless device. A client application on the portable computing device reassembles the media file from the first and second portions.

### CROSS REFERENCE TO RELATED APPLICATIONS

This application is a continuation-in-part application of U.S. application Ser. No. 09/505,486, entitled “Audio Synthesis Using Digital Sampling of Coded Waveforms,” filed on Feb. 16, 2000, which is incorporated by reference herein. This application also claims priority under 35 USC §119(e) from Provisional Application Serial No. 60/244,059, entitled “Method and Apparatus for Delivering Media Data via Wireless Devices,” filed on Oct. 27, 2000, which is incorporated by reference herein.

### FIELD OF INVENTION

The present invention relates to methods and systems that transmit data between computerized devices. In particular, embodiments of the invention allow a server computer to send a first portion of a media data file to a portable computing device by a first communications channel and to send a second portion of the media data file to the portable computing device by a second communications channel.

### BACKGROUND OF THE INVENTION

Portable computing devices have enjoyed increasing popularity in recent years. Portable computing devices may include handheld computers, wireless telephones, and personal digital assistants (“PDAs”). Over time, portable computing devices have acquired increasing functionality, and many such devices now provide their users with rich experiences not possible just a few years ago. For example, many portable computing devices now include an ability to transmit and receive wireless communications. The ability to communicate wirelessly has further increased the utility of portable computing devices. Wireless communications allow portable computing devices to access electronic networks such as the Internet. Thus, portable computing devices may provide their users with rich interactive experiences resembling those available over the Internet to personal computer users.

The “portability” of portable computing devices typically requires the devices to have an internal power supply (e.g., batteries) that supports mobility. Unfortunately, a portable computing device's establishment and maintenance of a wireless connection accelerates consumption of the portable computing device's power supply. In addition, some wireless communication channels may offer widespread availability but do not adequately support high bandwidth communications for many applications available on conventional desktop computers. Thus, users may have to choose between conserving battery power and receiving limited wireless communications or receiving wireless communications for a period limited by ever diminishing battery power.

If the portable computing device's batteries have already been reduced due to the user's other activities with the device, then the process of establishing a wireless communication may consume much of the device's remaining battery power. Under such circumstances, establishing and maintaining a wireless connection between the portable computing device and another computing system may not be possible for any length of time. Unfortunately, providing media data (audio, video, and text data, and combinations thereof) to portable computing devices conventionally requires that the communication channel remain open throughout the user's entire experience with the media. For example, listening to a three-minute-long song transmitted wirelessly to a portable computing device typically requires that a wireless communication of at least three minutes be maintained. In addition, efforts to protect the intellectual property rights of the media data's owner(s) may further increase the length of time that the portable computing device needs to maintain the wireless communications channel.

Accordingly, portable computing device users would likely benefit from an improved portable computing device that would allow them to enjoy various forms of media data without having to worry about draining the device's internal power supply and without restrictions on the length of time required to perform the media data. Of course, owners of the intellectual property rights to media data would also like to see increased usage of media data on portable computing devices, but these owners would likely not wish to jeopardize their ownership rights to the media data provided to the portable computing devices.

### SUMMARY OF THE INVENTION

Embodiments of the invention provide streaming media to portable computing devices without requiring maintenance of a wireless connection to the source of the streaming media throughout playback of the media data on the portable computing device. The portable computing device receives a media file in at least two portions, assembles the portions to form the media file, and plays the media file before destroying it to preserve the intellectual property rights of the media file's owners. The portable computing device typically receives the two file portions over two separate communications channels. In some embodiments, at least one of the communications channels is a wireless communication channel and the portable computing device is configured to reduce power consumption in the device by turning off the device's wireless receive-transmit subsystem once the second file portion has been received. Portable computing devices may include handheld computers, telephones, pagers, personal digital assistants (“PDAs”), and other similar computing devices having an ability to obtain data wirelessly. The media file may comprise audio, video, and/or text data formats.

Embodiments of the invention further provide a method for playing a media file in a portable computing device. The method comprises receiving a first file portion in the portable computing device via a first communication channel, wherein the first file portion is unusable as a media file. A second file portion is received in the portable computing device via a second communication channel, wherein the second file portion is unusable as a media file. The media file is then created in the portable computing device from the first file portion and the second file portion.

Embodiments of the invention also provide a method for preparing media data for transmission to a portable computing device. The method comprises creating a first file portion by removing elements from a media file and creating a second file portion from the elements removed from the media file. The second file portion may also contain sequencing information useful in re-creating the media file, according to an embodiment of the invention.

Embodiments of the invention further provide a portable computing device that comprises a media client configured to request a first file portion from a client computing device. The portable computing device also includes a transceiver configured to receive a second file portion over a wireless communication channel. The first and second file portions are unusable as media files. The media client is further configured to assemble a media file using the first file portion and a second file portion.

Embodiments of the invention provide a media playback device that comprises a first reception means for receiving a first file portion over a first communications channel, wherein the first file portion is unusable as a media file. The media playback device also includes a second reception means for receiving a second file portion over a second communications channel, wherein the second file portion is unusable as a media file. A media assembly means in the media playback device assembles a media file from the first file portion and the second file portion.

Embodiments of the invention further provide a media server for transmitting media data to a portable computing device. The media server may have a means for creating a first file portion by removing elements from a media file, wherein the first file portion is unusable as a media file. The media server may also include means for creating a second file portion from the elements removed from the media file, wherein the second file portion is unusable as a media file.

Embodiments of the invention also provide a media client for processing media files on a portable computing device. The media client may comprise a first file manager configured to request a first file portion over a first communications channel, wherein the first file portion is unusable as a media file. A second file manager on the media client may be configured to request a second file portion over a second communications channel, wherein the second file portion is also unusable as a media file. The media client may also include a media file reconstructor configured to reconstruct a media file from the first file portion and the second file portion.

Embodiments of the invention further provide a computer program product for use in connection with a portable computing device to provide media data for execution by a media client associated with the portable computing device. The portable computing device includes a memory configured to store the computer program product. The computer program product comprises a first file portion rendered unusable as media data by removal of a plurality of data elements. The computer program product also includes a second file portion containing the plurality of data elements removed from the first file portion and sequencing information that explains where the plurality of data elements removed should be placed in the first file portion to produce a media file that may be played by the media client.

Embodiments of the invention also include a computer-readable medium containing instructions for controlling a portable computing device to play a media file. The computer-readable medium instructions may comprise receiving a first file portion in the portable computing device via a first communication channel, wherein the first file portion is unusable as a media file. The instructions may also include receiving a second file portion in the portable computing device via a second communication channel, wherein the second file portion is also unusable as a media file. The instructions further include creating the media file in the portable computing device from the first file portion and the second file portion.

### BRIEF DESCRIPTION OF THE DRAWINGS

An embodiment of the invention will be described below relative to the following figures.

FIG. 1A is a block diagram of an apparatus for distributing portions of media files to client computers, according to an embodiment of the invention.

FIG. 1B is a block diagram illustrating the transfer of essential media (“EM”) files from the media server to a portable computing device, according to an embodiment of the invention.

FIG. 1C is a block diagram illustrating a portable computing device, according to an embodiment of the invention.

FIG. 2A illustrates a representative media file, according to an embodiment of the invention.

FIG. 2B illustrates portions of a media file that may be removed by a media server to form a residual media (“RM file”), according to an embodiment of the invention.

FIG. 2C illustrates an RM File having removed portions, according to an embodiment of the invention.

FIG. 2D illustrates components of the EM file, according to an embodiment of the invention.

FIGS. 2E and 2F respectively illustrate a media file having a corresponding RM file that itself comprises an encrypted media file, and an EM file that contains a decryption key for the RM file, according to an embodiment of the invention.

FIG. 3 is a block diagram illustrating a plurality of portable computing devices receiving media file components, e.g., RM and EM files from a media server, according to an embodiment of the invention.

FIG. 4 is a diagram illustrating the processing of media file components among the media server, a client module on a client computer, and a media client on a portable computing device, according to an embodiment of the invention.

FIG. 5 is a flowchart illustrating the process followed by the client module on the client computer, according to an embodiment of the invention.

FIG. 6 is a flowchart that illustrates how a media client on a portable computing device may reconstruct media files from components such as RM and EM files, according to an embodiment of the invention.

FIG. 7 is a flowchart illustrating the media client's actions in retrieving RM files from the media server, according to an embodiment of the invention.

FIG. 8 is a block diagram illustrating an embodiment of the invention in which the portable computing device receives RM files via a first wireless communication channel and EM files via a second wireless communication channel.

FIG. 9 is a diagram illustrates a portable computing device having a removable memory device containing RM files, according to an embodiment of the invention.

### DETAILED DESCRIPTION OF AN EMBODIMENT OF THE INVENTION

Embodiments of the invention provide streaming media to portable computing devices without requiring maintenance of a wireless connection to the source of the streaming media throughout the media's performance on the portable computing device. The portable computing device receives a media file in at least two portions, assembles the portions to form the media file, and plays the media file before destroying it to preserve the intellectual property rights of the media file's owners, according to an embodiment of the invention. Portable computing devices may include handheld computers, telephones, pagers, personal digital assistants (“PDAs”), and other similar computing devices having an ability to obtain data wirelessly. The media file may comprise audio, video, and/or text data formats.

The portable computing device typically obtains the first portion of a media file during periods that will not tax the device's internal power sources and/or over a high bandwidth communication channel. For example, a client computer may forward the first portion to the portable computing device while the portable computing device is connected to the client computer over a wired communication channel and while the portable computing device is powered from an external source. A media server has typically formed the first portion from a disabled media file and formed the second portion, typically smaller than the first portion, with information useful in reconstructing the media file from the first portion. If the portable computing device already has the first portion when a user wishes to play the media file, then the portable computing device only needs to activate its wireless reception device long enough to receive the second portion.

Embodiments of the invention may reduce power consumption in a portable computing device's wireless receive-transmit subsystem (e.g., transceiver) when this subsystem receives streaming media data. Enabling power savings in a portable computing device is generally advantageous. For example, the media playback chip in an audio or video playback device, such as a Rio MP3 player, typically runs 10 to 15 hours on an AA battery. With the introduction of new wireless devices with MP3 playback capability and storage, such as those enabled by Qualcomm's MSM3300 chipset, the desire to access media data in a power efficient manner has increased. Reducing the size of the file streamed should reduce the amount of power consumed in receiving the file. Accordingly, a media server may strip MP3 files of some data, rendering them unusable until recombined with the data stripped out. A file containing the removed data, the second file portion above, may be known as an “Essential Media” (“EM”) file. A file from which data was removed, the first file portion above, may be known as the “Residual Media” (“RM”) file. The RM file, which will not reveal the media file, may be provided to the portable computing device well ahead of a user's desire to play the media file. When the portable computing device's user wishes to play the media file, the portable computing device needs its receive-transmit subsystem for receiving the smaller EM file, rather than the entire media data file, thus reducing overall power consumption in the portable computing device.

The RM files are typically larger, sometimes much larger, than the EM files. The portable computing device may receive the RM files and store them in a memory. The RM files may be provided from both wired and wireless sources, and may be received well in advance of the EM files, according to embodiments of the invention. Once the EM file has been received, then media client software on the portable computing device may reconstruct the media file from the RM file and the EM file. For example, media client software on the portable computing device may combine an RM file and an EM file to recreate an MP3 file that is then played for the user. The media client software may delete the media file as it is played to the user.

An embodiment of the invention using the MSM3300 chipset mentioned above further illustrates how internal power consumption may be reduced in a portable computing device. The EM file corresponding to a typical MP3 file is fairly small, typically about 30 KB, and the receivers in most portable computing devices can complete reception of the EM file in just a few seconds. To receive the EM file by establishing a connection with a base station transceiver, the portable computing device merely activates its receive-transmit circuitry, such as an RFR3300, RFT 3100, IFR3300, or PA3100 device. Once the EM file has been received on the portable computing device, the receive-transmit circuitry may be powered down or put into a sleep mode to save power. Playing a typical MP3 file typically takes about 3 to 4 minutes. When the media client software has finished playing the media file, the media client software may instruct the receive-transmit circuitry to power up again to receive the next EM file for another media file. Of course, in some embodiments of the invention, more than one EM file may be provided to the portable computing device at a time so that the media client software could reconstruct and play several media files before re-powering the device's receive-transmit circuitry. When the media client is configured to allow performance of media files off line (e.g., without an active connection to the media server that provided the EM files), then the media client may include a counter to determine the number of times that a media file(s) has been played to determine the royalty payment due to the owner of the intellectual property in the media file(s).

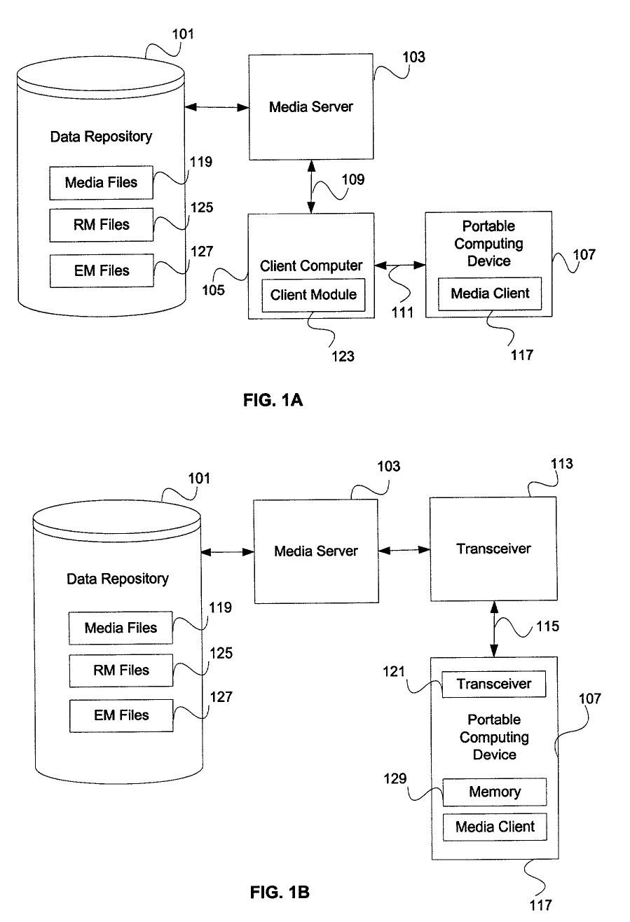

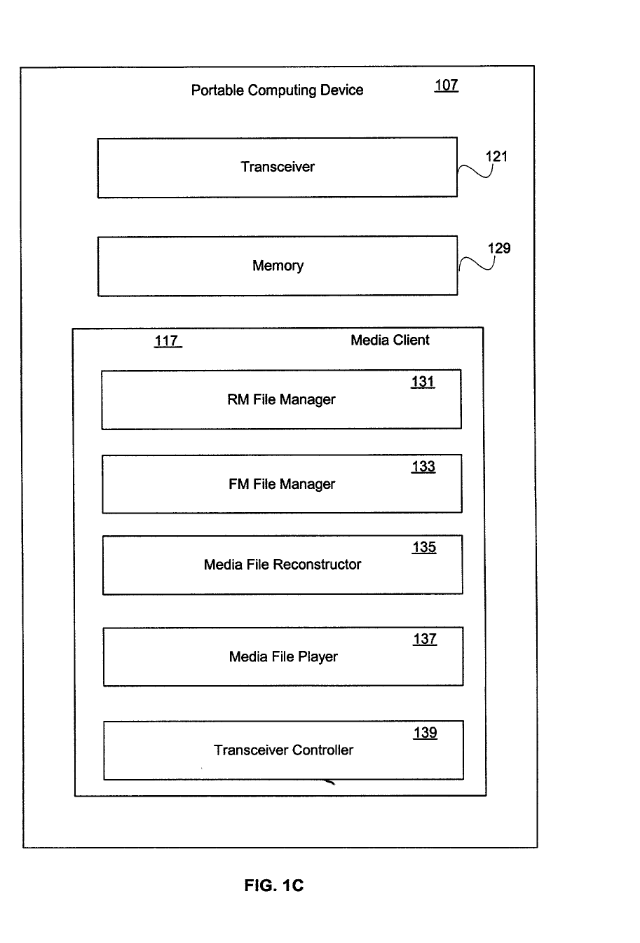

FIG. 1A is a block diagram of a system for distributing portions of media files from a media server 103 to a client computer 105, according to an embodiment of the invention. The media server 103 retrieves media files 119 from a data repository 101. A media server 103 may process the media files 119 in a manner that prevents the files from being used by parties who do not have access permission and from being misused by parties who have only limited usage rights to the media files 119. As previously mentioned, the media server 103 removes data from the media files 119 to produce RM files 125. The RM file 125 is unusable to anyone who does not know both from where the data was removed and what the removed data comprised, according to an embodiment of the invention. For an added measure of security, the media server 103 may encrypt the RM file 125, according to an embodiment of the invention. For example, the RM file 125 may be encrypted using a key derived from the information removed.

A user may create a data connection 111 between the client computer 105 and a portable computing device 107 in various ways. For example, the user may drop the portable computing device 107 into a docking station, or synch cradle, associated with the client computer 105 or connect the portable computing device 107 to the client computer 105 via a peripheral port. Of course, it is also possible to connect the portable computing device 107 directly to the Internet without the client computer 105, provided that the portable computing device is configured to handle the appropriate Internet protocols. In such an embodiments, for example, the cradle could be connected to a DSL modem, cable box, or an Internet application. The connection between the client computer 105 and the portable computing device 107 may also provide a power supply to the portable computing device 107 such that transferring data to the portable computing device 107 will drain the portable computing device's batteries.

A client module 123 on the client computer 107 may establish communications with the media server 103. The client module 123 may request the media server 103 to transfer RM files 125 from a data repository 101 to the client computer 107. The communication channel between the client computer 107 and the media server 103 may be fairly high bandwidth. The client module 123 may be programmed to request RM files 125 at predetermined intervals as well as upon user request. Accordingly, the client module 123 may retrieve RM files 125 without the client computer 107 necessarily being associated with a portable computing device. In such circumstances, the client module 123 may store the RM files 125 in a memory associated with the client computer 105.

A media client 117 associated with the portable computing device 107 may request the RM files 125 from the client computer 107. Alternatively, the client module 123 may push the RM files 125 to the portable computing device 107. The media client 117 may store the RM files 125 in a memory 129 on the portable computing device 107. The RM files 125 may remain on the portable computing device 107 for some time before being combined with a corresponding EM file 127 to re-form the media file 119.

FIG. 1B is a block diagram illustrating a system for transferring EM files 127 from the media server 103 to the portable computing device 107, according to an embodiment of the invention. As discussed above, the portable computing device 107 typically receives RM files 125 prior to receiving EM files 127. When a user of the portable computing device 107 engages the media client's functionality, the media client 117 accesses any RM files 125 stored in its memory 129 to determine the set of corresponding EM files 127 corresponding to the RM files 125.

When the user initiates media services, the media client 117 on the portable computing device 107 initiates a wireless communication 115 through a transceiver 121 with a transceiver 113 associated with the media server 103. The media client 117 may request all or some of the EM files 127 corresponding to the RM files 125 previously downloaded. Once the EM files 127 arrive at the portable computing device 107, then the media client 117 may terminate the wireless communication 115 with the media server 103.

Once the media client 117 has obtained the EM files 127, the music playback process may begin. The media client 117 reconstructs the media file 119 using the RM file 125 and the EM file 127. The media client 117 begins playback of the media file 119 through appropriate outputs associated with the portable computing device 107. The playback process may repeat until all the media files in the corresponding playlist have been performed. Once the media client 117 has performed the entire media file 119, then another iteration may begin of the media file transfer process on the portable computing device 107.

The portable computing device 107 uses its transceiver 121 to establish wireless communications with a transceiver 113 associated with the media server 103. Once communications have been established, the media client 117 requests the appropriate EM file(s) 127 from the media server 103. The media client 117 identifies the requested EM files 127 along with any necessary account and/or payment information. After verifying the media client's authorization to receive EM files 127, the media server 103 then uses the identifying information provided by the media client 117 to locate the appropriate EM files 127 in the data repository 101. The media server 103 forwards the EM file(s) 127 to the transceiver 113. The transceiver 113 transmits the EM file(s) 127 to the portable computing device 107 via the transceiver 121.

Once the media client 117 confirms reception of the EM files, the media client 117 instructs the transceiver 121 to disconnect from the transceiver 113 and shut down, according to an embodiment of the invention. The EM files 127 are relatively small files and their transmission typically transpires much faster than would the transfer of a corresponding RM file.

Having received the EM file(s), the media client 117 may then reconstruct the media file(s) from the RM file(s) 125 and from the EM file(s) 127. Reconstruction essentially comprises reversing the steps used to prepare the RM file 125 and EM file 127 from the original media file 119. As previously discussed, embodiments of the EM file 127 may even include instructions for reconstituting the media file 119. In reconstructing the media file, the media client may also attend to intellectual property rights issues such as maintaining a counter of the number of times that the file has been played.

The media client 117 may provide media file(s) 119 to the user in a variety of formats. For example, the media client 117 may provide a playlist to the user or may simply begin playing the media file 119 for the user. The media client 117 may be equipped to destroy the media file 119, or portions of it, subsequent to playing to the user. Destroying the media file 119 may preserve various intellectual property rights of the media files' owners.

FIG. 1C is a block diagram illustrating a portable computing device 107, according to an embodiment of the invention. The portable computing device 107 may include a memory 129, a transceiver 121, and a media client 117.

The media client 117 may include various modules configured to perform various tasks for the media client. An RM file manager 131 retrieves RM files onto the portable computing device 107 and stores them in the memory 129. When the media client 117 engages the RM file manager 131, the RM file manager 131 may first determine if the portable computing device 107 has an established connection with a client computer, such as the client computer 105 shown in FIG. 1A. If the RM file manager 131 cannot find a client computer connection, then the RM file manager 131 may attempt to obtain RM files via a wireless connection using the transceiver 121.

Similarly, an EM file manager 133 retrieves EM files onto the portable computing device 107. The EM file manager 133 may be configured to store EM files in the memory 129, although in some embodiments, the EM files may be used immediately and not stored in the memory 129. When the media client 117 engages the EM file manager 133, the EM file manager 133 determines what RM files, if any, have been stored in the memory 129 in order to identify the set of complementary EM files that need to be obtained. The EM file manager 133 determines if the portable computing device 107 has an established connection with a client computer, such as the client computer 105 shown in FIG. 1A. If the EM file manager 133 cannot find a client computer connection, then the EM file manager 133 may attempt to obtain EM files via a wireless connection using the transceiver 121.

A media file reconstructor 135 takes an RM file, finds a matching its matching EM file, and reconstructs an original media file. A media file player 137 may play, or perform, the media file. The media file player 137 and the media file reconstructor 135 may be configured to work together such that a complete copy of the media file is never resident on the portable computing device 107 at any one time. For example, the media file reconstructor 135 may reconstruct a section of a media file (e.g., a playable amount of the media file less than the whole media file) and provide the section to media file player 137 that deletes the section as soon as it is played. While the media file player 137 is playing one media file section, the media file reconstructor 135 may be reconstructing the next media file section to be played. In embodiments of the invention where media file security is less of a concern, the media file reconstructor 135 may be configured to reconstruct a media file and provide the reconstructed media file to the media file player 137.

A transceiver controller 139 provides instructions to the transceiver 121. For example, the transceiver controller 139 may instruct the transceiver 121 to power down or enter into a sleep mode upon receipt of an RM file or an EM file. Reducing power consumption in the transceiver 121 may extend the useful life of the portable computing device's internal power supply (e.g., its batteries). The transceiver controller 139 may operate with the RM file manager 131 and the EM file manager 133 in obtaining RM files and EM files from media servers and other file supplying intermediaries. For example, in some embodiments of the invention, RM files may be obtained from other portable computing devices using a connection, such as an IR transceiver, that sends files from one portable computing device to another. The transceiver controller 139 may also be configured to operate with more than one transceiver on the portable computing device 107.

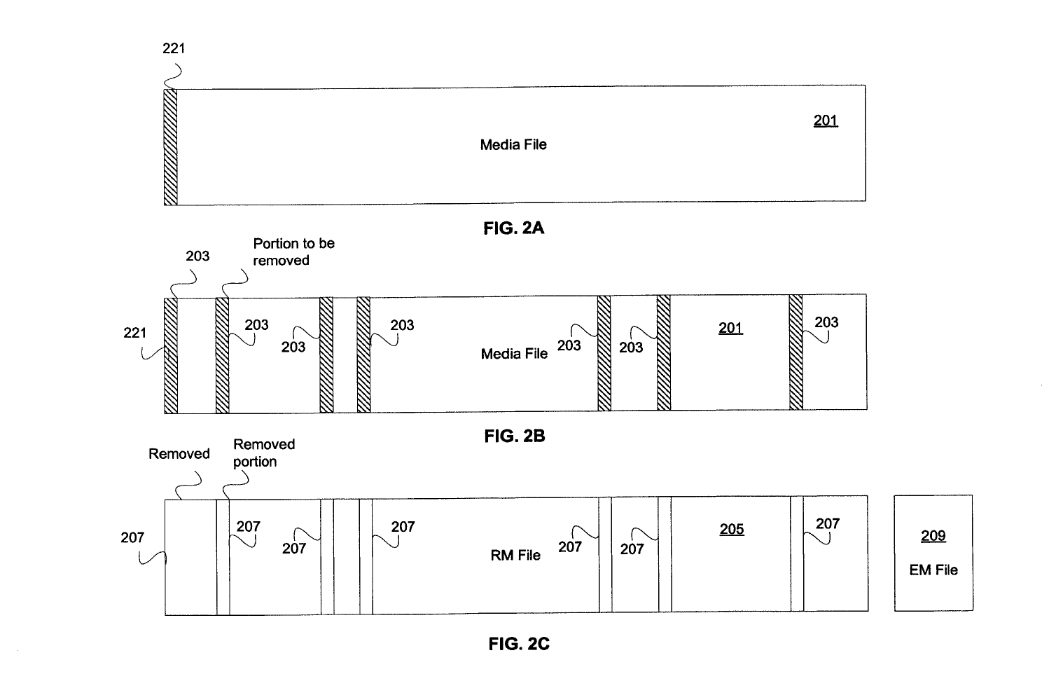

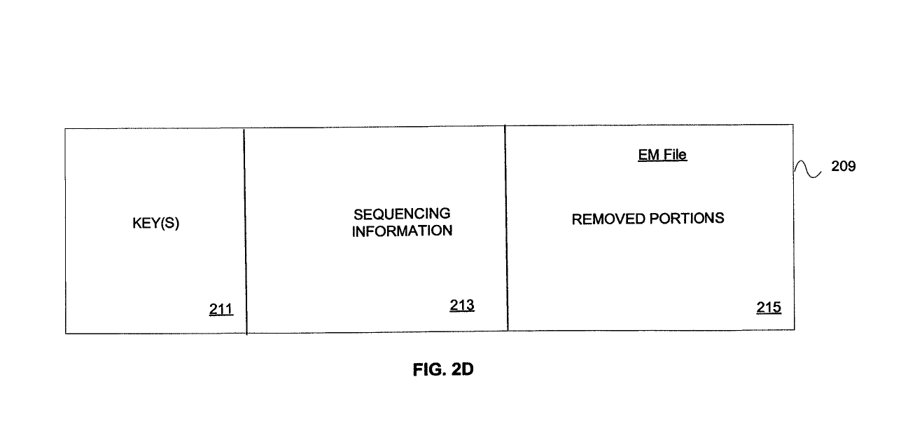

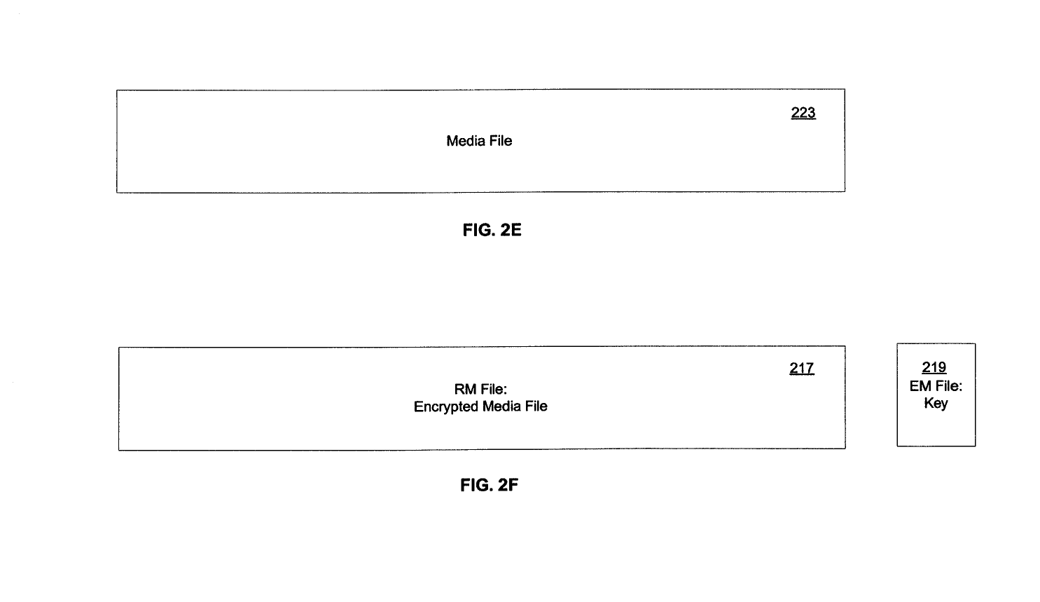

FIG. 2A illustrates a media file 201. The media file 201 may include data having a variety of types and formats, such as video data, audio data, and text data. The media file 201 typically includes a header 221 that describes the file's contents and organization.

FIG. 2B illustrates portions 203 of the media file 201 that may be removed by the media server to form an RM file, according to an embodiment of the invention. The removed portions 203 may include the header 221 and other portions of the file selected according to a predetermined formula. For example, one formula may call for the removal of every X bytes, where X is a positive integer greater than 50. The formula may also approximate randomness since the information removal scheme will either be incorporated into the EM file or provided to the media client in some other manner. In any event, the media client 117 has access to the information removal scheme when it is reconstructing the media file from the RM file.

FIG. 2C illustrates an RM file 205 having removed portions 207, according to an embodiment of the invention. The removed portions 207 may contain all 0s, all 1s, or another random and otherwise meaningless pattern. The RM file 205 may also be created without filler for the removed portions 207 from the media file 201; in such an embodiment, the RM file 205 will generally be smaller than the original media file by the sum of the removed portions 207. In any event, a person, or computer program, examining the RM file 205 would find no information identifying the file as containing media data. Even if a person guessed that the file contained media data, the person would still not have the file header information for the original media file. Assuming the person could somehow reconstruct the file header, the person would still not know what media data had been removed or from where it was removed. Nevertheless, for an added layer of security, in some embodiments, the RM file 205 may be encrypted. The encryption key may even be derived from the removed portions 203. FIG. 2C also illustrates an EM file 209 that has been constructed, at least in part, by the removed portions 203 of the media file 201.

FIG. 2D illustrates components of the EM file 209, according to an embodiment of the invention. As previously discussed, the EM file 209 contains information needed by a media client in reconstructing the media file 201 from an RM file 205. The EM file 209 may contain one or more key(s) 211 that may be used by the media client to decrypt the RM file 205. The EM file 209 contains sequencing information 213 that explains where and how to add removed portions 215 to the RM file 205 to reproduce the media file 201. As previously discussed, the media client may reproduce the media file 201 while the file is being played, and the media client may destroyed played portions of the media file 201 as soon as they are played. In this manner, the media client may thwart unauthorized efforts to copy the media file 201.

Embodiments of the invention may protect intellectual property rights in the media file 201 by removing information from the media file and by encrypting the file. In alternate embodiments of the invention, the media file may be protected by just removing information from the media file while in another alternate embodiment of the invention, the media file may be protected by encryption alone. FIGS. 2E and 2F respectively illustrate a media file 223 with a corresponding RM file 217 that represents an encrypted media file, and an EM file 219 that contains a decryption key for the RM file 217, according to an embodiment of the invention. The RM file 217 may be applied to situations where encryption technology alone is deigned sufficient for protecting the media file 223 from unauthorized users. For example, this embodiment may be useful if the media client is adapted to decrypt small portions of the RM file 217 as it plays the file, such that an unencrypted version of the media file 223, as a whole, never resides on the portable computing device.

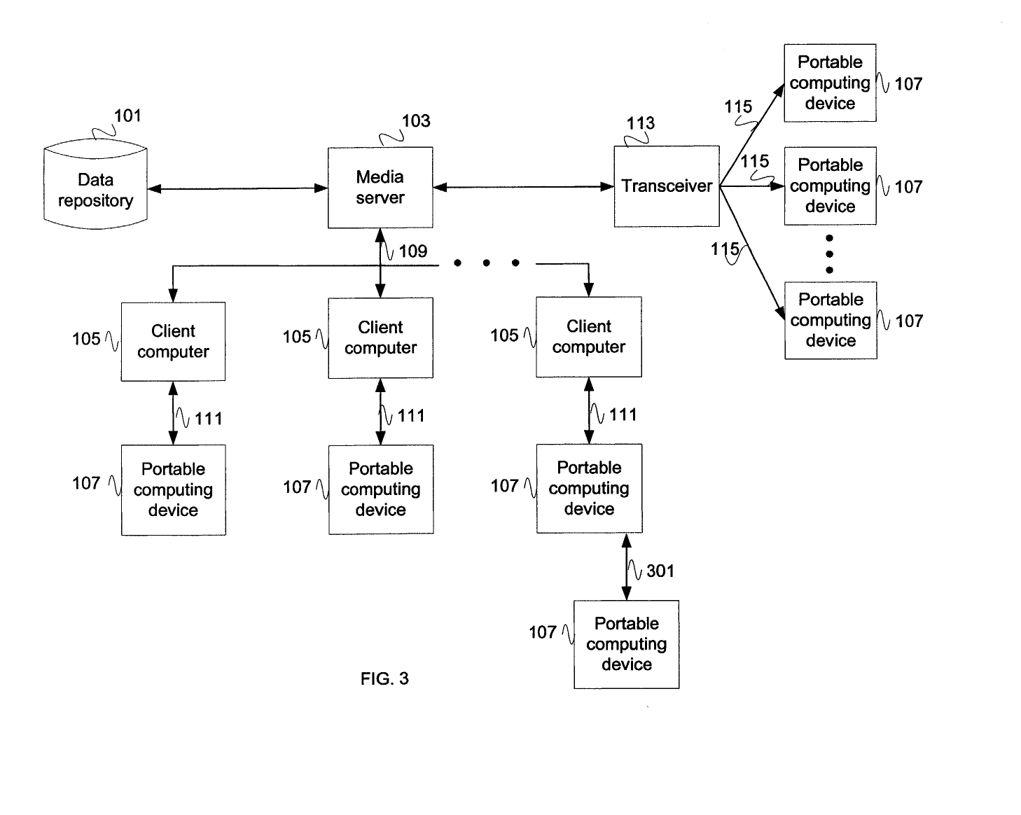

FIG. 3 is a block diagram illustrating a plurality of portable computing devices 107 receiving media file components (e.g., RM and EM files) from the media server 103, according to an embodiment of the invention. FIGS. 1A and 1B illustrated how a single portable computing device 107 may receive media file components (e.g., an RM file and an EM file). Of course, embodiments of the invention comprise a media server 103 configured to provide a plurality of different RM files and EM files to a plurality of portable computing devices 107.

The media server 103 receives RM file requests from the plurality of client computers 105. The client computers 105 may request RM files corresponding to the same media file or corresponding to different media files, depending upon overall system configuration and user preferences. Thus, two client computers 105 may request a RM file corresponding to a collection of blues music, while another client computer 105 may request an RM file corresponding to a video of Tibetan traditional dances. As previously discussed, the RM files received on the various client computers 105 may be forwarded to a corresponding portable computing device 107. For example, the client computer 105 and the portable computing device 107 may establish a data transmission connection via a docking station or a synch cradle.

A portable computing device user who desires to play a media file while the portable computing device 107 is connected to the client computer 105 may typically obtain the EM file corresponding to an RM file via the client computer 105. Communication channels provided by the client computer 105 are typically superior to other communication channels (e.g., a wireless connection) that could be provided to the portable computing device 107. In addition, a data connection between the client computer 105 and the portable computing device 107 may also indicate an external power supply for the portable computing device 107. Thus, in such situations, the EM files may be obtained via the client computer 105.

When the portable computing device 107 is disconnected from the client computer 105, then the portable computing device 107 may obtain the EM files wirelessly via the transceiver 113. Since transmission of the EM files can generally be accomplished quickly, the transceiver 113 may transmit a number of different EM files to a number of different portable computing devices 107. Of course, the media server 103 may use more than one transceiver 113, and the system may employ more than one media server 103.

FIG. 3 also illustrates another method by which portable computing devices 107 may obtain RM files. One portable computing device 107 may use a transceiver (e.g., an IR transceiver) to establish a wireless connection 301 to another portable computing device 107 and then “beam” an RM file(s) to another portable computing device 107. For example, one friend may tell another friend about a music playlist that she has enjoyed and then beam the playlist, including the corresponding RM files, to the other friend's portable computing device 107 over the connection 301. The friend may then obtain EM files in the manner described above.

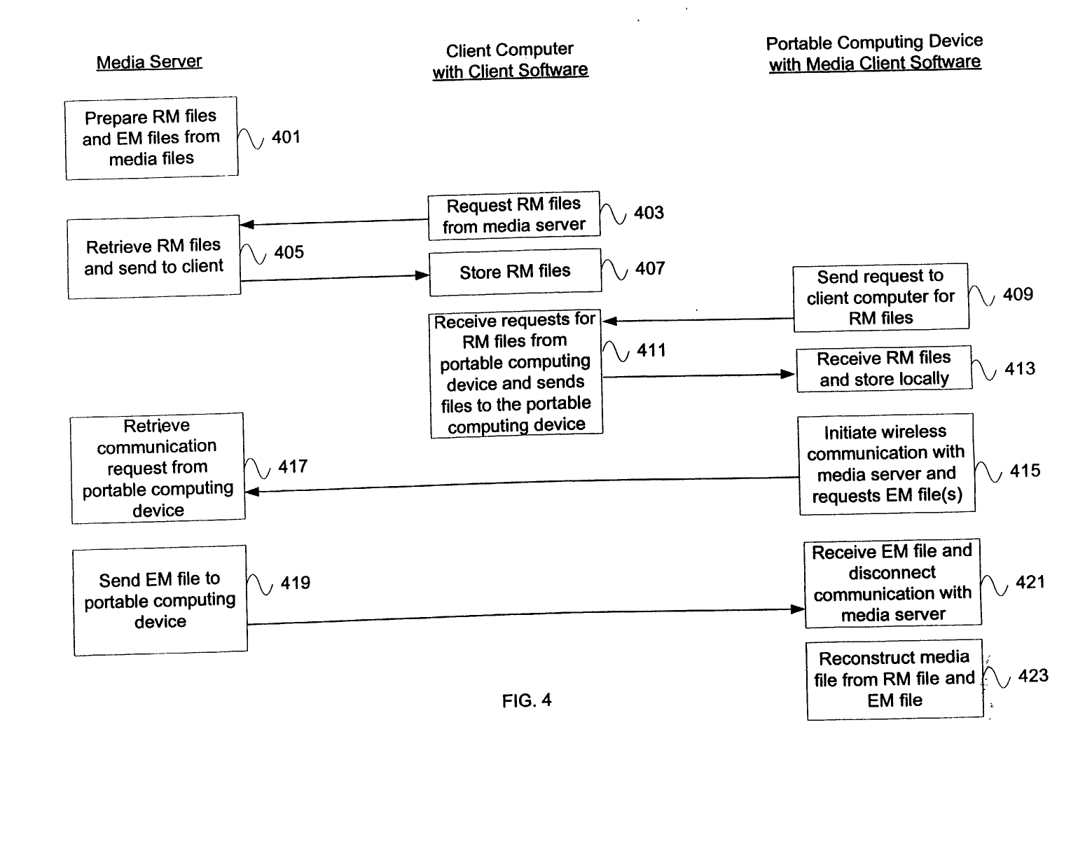

FIG. 4 is a diagram illustrating the processing of media file components among the media server, a client computer equipped with a client module, and a portable computing device equipped with a media client, according to an embodiment of the invention.

A media server prepares 401 RM files and EM files from media files as previously discussed (e.g., FIGS. 2A-2F) and may store them in a data repository. At some later time, the client computer requests 403 RM files from the media server. The media server may retrieve 405 RM files from the data repository and send them to the client computer. The client computer may then store 407 the RM files received from the media server.

When a portable computing device is connected with the client computer (e.g., via a synch cradle), the portable computing device's media client sends 409 a RM file request to the client computer. The client computer receives 411 the RM file request, locates any RM files stored in memory, and sends the RM files to the portable computing device. The portable computing device receives 413 the RM files and stores them in a local memory.

At a later time, typically after the portable computing device has been disconnected from the client computer, a portable computing device user may choose to play the media file corresponding to the RM files stored on the portable computing device. The media client on the portable computing device initiates 415 a wireless communication with the media server. The media server receives 417 the communication, and the media client synchronizes the communications between the two devices. The media client then requests from the media server the EM files associated with the stored RM files. After completing any appropriate security and/or payment procedures, the media server locates 419 the appropriate EM files and sends them to the portable computing device.

After the portable computing device receives the EM files, the media client may disconnect 421 wireless communications with the media server. Terminating this connection once the EM files have been received typically reduces the power consumption in the portable computing device. The media client may then supervise the reconstruction 423 of the media file from the RM file and the EM file. The portable computing device may then play the reconstructed media file for the user.

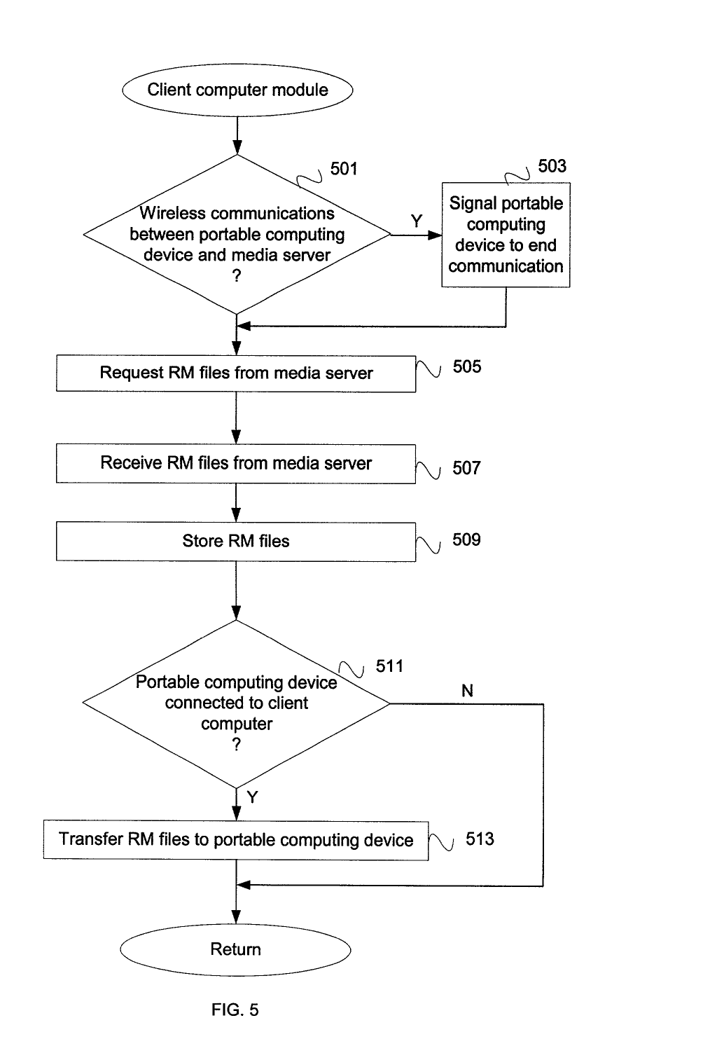

FIG. 5 is a flowchart illustrating the procedure followed by the client module on the client computer, according to an embodiment of the invention. For example, this procedure may be used by the client module 123 on the client computer 105 shown in FIG. 1A.

The client module determines 501 if any portable computing devices connected to the client module's client computer are engaging in wireless communications involving media file components with a media server, according to an embodiment of the invention. The client module may make this determination by sending an appropriate query to a media client on the portable computing device. If a portable computing device is engaging in wireless communications with a media server, then the client module signals 503 the portable computing device to terminate its wireless communications with the media server. Of course, the media client associated with the portable computing device may choose to continue its wireless communications but such communications cannot typically communicate with the efficiency that the client computer could communicate with the media server. In addition, the wireless communication may well consume more of the portable computing device's internal power supply (e.g., batteries). In any event, embodiments of the client module need not necessarily conduct a check to determine if the portable computing device is engaging in wireless communications, although such checks may be useful in assisting the media client in further conserving the internal power supply on the portable computing device.

The client module requests 505 RM files from the media server. The client module may maintain a list of media server addresses and/or the identity of a meta media server that dispenses media server addresses based on proximity to the client and/or particular content types. The media server may verify and validate the request for RM files before sending them to the client computer. The media server may also ask for other information such as passwords or payment. The client module receives 507 the RM files from the media server and typically stores 509 the RM files in the client computer's memory.

The client module determines 511 if a portable computing device is in communication with the client computer. If the client computer presently has no connections to a portable computing device that can receive the RM files, then the client computer may terminate its operations with respect to transferring RM files to one or more portable computing devices. If the client computer is in communication with one or more portable computing devices, then the client computer may transfer 513 RM files to the portable computing device(s) 107. As previously discussed, the RM files typically represent a larger portion of an original media file than a RM file's corresponding EM file.

The client computer may be configured to execute the tasks of checking for portable computing devices and transferring RM files at periodic intervals. For example, when a portable computing device is placed in a docking station, or synch cradle, associated with a client computer, a media client associated with the portable computing device may send an RM file request to the client module. The client module may receive the RM file request, locate the RM files previously stored on the client computer, and forward them to the media client. Of course, the portable computing device may already be in the client computer's synch cradle when the client module requests the RM files from the media server. In such situations, the client module may receive the RM files and provide them to the portable computing device rather than waiting for the media client to request the RM files.

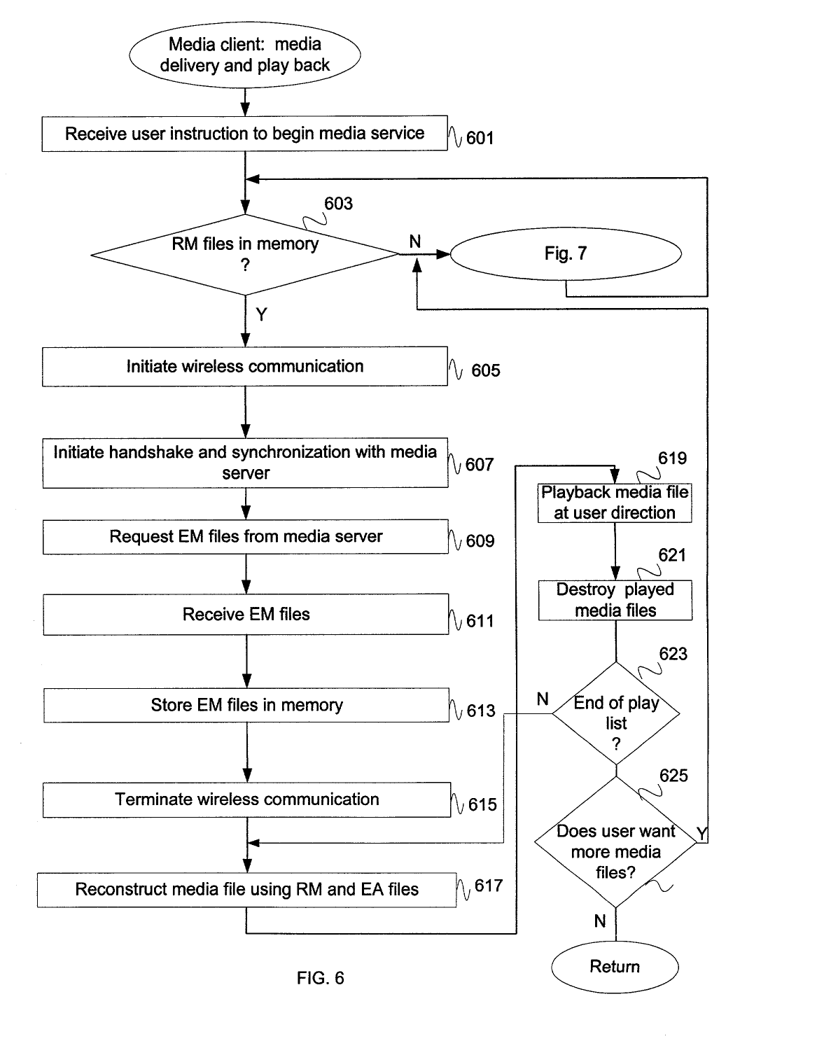

FIG. 6 is a flowchart illustrating how a media client on a portable computing device may reconstruct media files from components such as RM and EM files, according to an embodiment of the invention. For example, the media client 117 shown in FIG. 1A may follow this procedure.

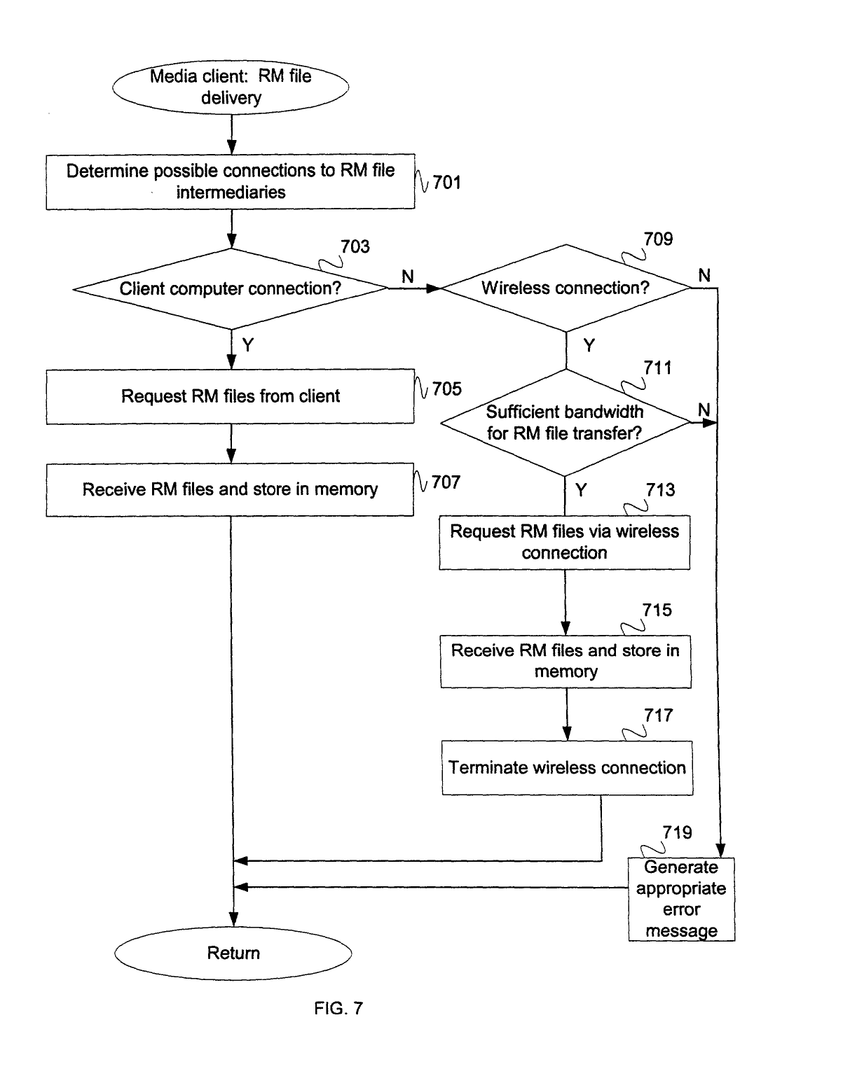

The media client receives 601 a user's instructions to begin media services. The media client determines 603 if the portable computing device's memory contains RM files. If the portable computing device's memory does not contain RM files, then the media client may follow a procedure like that described in FIG. 7 to obtain RM files.

If the portable computing device's memory contains RM files, then the media client instructs 605 the portable computing device's transceiver to initiate a wireless communication with the media server. The media client may assist the transceiver in initiating 607 and completing any handshake and/or synchronization procedures that need to be completed with the media server and/or its transceiver. The media client may now communicate with the media server.

The media client examines the RM files to determine the appropriate set of corresponding RM files. The media client requests 609 the appropriate EM file(s) from the media server. The media client receives 611 the EM file(s) from the media server and may store 613 the EM file(s) in a memory associated with the portable computing device. The media client now has at its local disposal all the file components (e.g., the EM and RM files) that it needs to reassemble and perform a media file for the user. Having the received the EM files, and already having the RM files in memory, the media client needs no further information in order to restore the media file, according to an embodiment of the invention. Moreover, disconnecting the wireless communication should help achieve the goal of lowering power consumption in the portable computing device. The media client may now terminate 615 the wireless connection with the media server. Terminating the wireless communication may cause the portable computing device's transmitter to enter a sleep mode or simply turn itself off. Terminating the wireless connection generally reduces power consumption in the portable computing device since the device no longer needs to expend battery power to maintain the connection with the media server.

The media client may reconstruct the media file in a variety of ways. In one embodiment, the media client uses the EM file as a road map for reconstructing the RM file. The media client may reconstruct 617 the media file using the RM file(s) and the EM file(s). The media client may retrieve instructions from the EM file that describe how to reconstitute the media file from the RM file and the EM file. For example, the media file may retrieve a key from the EM file that may be used to decrypt the RM file. Once the media client has decrypted the RM file, the EM file's instructions may indicate where media data has been removed from the RM file, how much media data has been removed, and where in the EM file the removed media data may be found.

The media client may play 619 the media file at the user's direction (step 621). For example, the reconstructed media file might contain 20 songs, but the user only wants to hear 10 of the 20 songs. To ensure additional security for the owners of the media file, the media client may refrain from assembling the media file, or some portions of the file, until the last possible instant and may destroy 621 the media file, or portions of the file, as soon as they are played. The media client determines 623 if the end of the playlist for a particular media file has occurred. If the playlist is not ended, then the media client may retrieve a next media file or a next portion of a media file.

If the playlist has reached its end, then the media client may determine 625 if the user of the portable computing device would like to receive more media files. If the user does not presently wish to receive more media files, then the media client may terminate its operations. On the other hand, if the user would like to receive more media files, then the media client will need to retrieve more RM files following a procedure such as that described in FIG. 7.

FIG. 7 is a flowchart illustrating a media client's actions in retrieving RM files from a media server, according to an embodiment of the invention. As previously discussed, EM files are typically smaller than RM files. Accordingly, portable computing devices typically benefit more from a higher bandwidth communication channel for receiving the RM files than is needed for receiving the EM files.

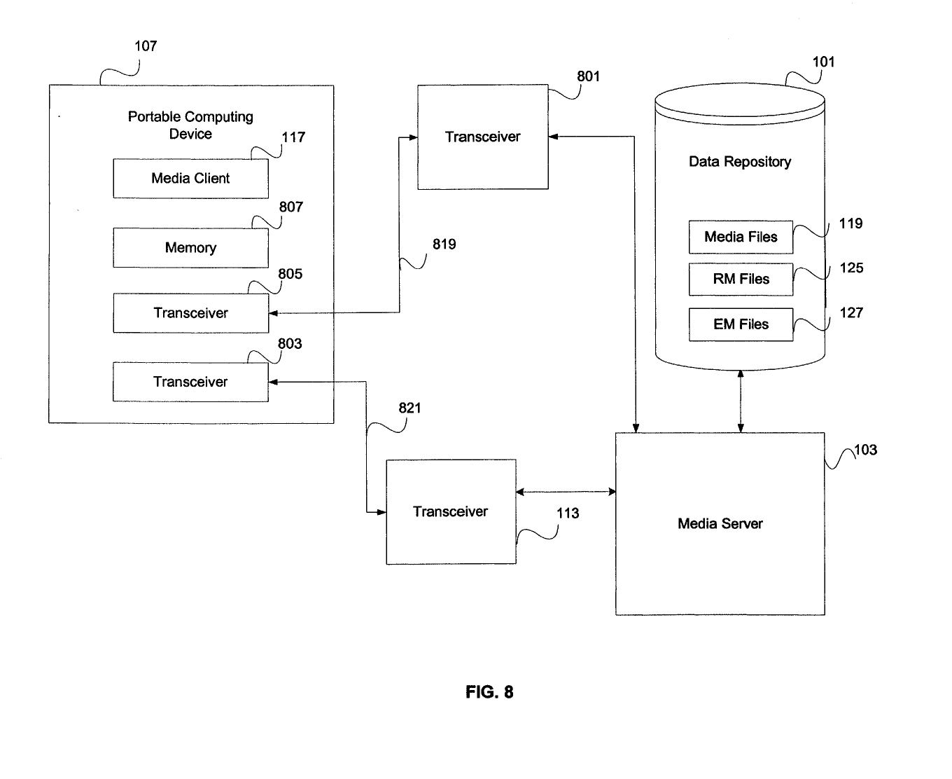

The media client determines 701 the possible connections to intermediary sources for RM files. For example, if the portable computing device is synched with a client computer, then the client computer may serve as an appropriate intermediary to the media server by providing sufficiently high bandwidth for transfer of the RM files. Also, the presence of a client computer also increases the likelihood that the portable computing device may have access to an external power supply. Various other intermediary repositories of RM files may be available to portable computing devices, and portable computing devices may also obtain RM files directly from media servers. For example, as discussed in FIG. 8, the portable computing device may use a transceiver to establish a wireless connection with a media server and receive RM files over the wireless connection.

The media client determines 703 if the portable computing device is connected with a client computer (or another intermediary source of RM files). If the portable computing device is connected with a client computer, then the media client requests 705 RM files from the client computer. If the client computer has no RM files to transfer to the portable computing device, then the client computer may request RM files from the media server (e.g., using the procedure described in FIG. 5). The media client then receives 707 RM files from the client computer and stores them in a local memory associated with the portable computing device.

If the portable computing device is not connected with a client computer, then the media client determines 709 if the portable computing device can establish a wireless connection with a media server. The media client may similarly determine if it can establish a wireless connection with an intermediary supplier of RM files. The media client typically first checks its own memory for RM files, then checks for a connection with a client computer before checking for a wireless connection, as described above. The media client may use a wide band communications channel to obtain RM files and a narrower band channel to receive EM files in some embodiments. However, in some embodiments of the invention, the media client may simply use the same channel to receive both EM and RM files. If the media client is able to establish a wireless connection with the media server, or another intermediary provider of RM files, such as an IR connection with another media client, then the media client determines 711 if the connection established provides sufficient bandwidth for the transmission of RM files. Over time, bandwidth constraints may become less burdensome such that the choice of whether to send EM files or RM files through one channel or two different channels becomes a question of cost and immediate availability rather than bandwidth. In any event, the media client will typically be configurable for communications using protocols through which EM and RM files may be obtained.

If the connection provides sufficient bandwidth, then the media client requests 713 RM files from the media server via the wireless connection. The media server may locate an appropriate RM file, or an appropriate set of RM files, and send them to the portable computing device. The media client receives 715 the RM file(s) and stores them in a local memory associated with the portable computing device. The media client then terminates 717 the wireless connection with the media server. In a typical configuration, the earlier the media client terminates the wireless connection, then the more power will be conserved in the portable computing device's internal power supply (e.g., its batteries).

If the media client cannot establish a wireless connection to the media server, or if the connection established with the media server has insufficient bandwidth, then the media client generates 719 an appropriate error message so that the user of the portable computing device may understand why the requested media file(s) cannot be played.

FIG. 8 is a block diagram illustrating an embodiment of the invention in which the portable computing device receives RM files via a first wireless communication channel 819 and EM files via a second wireless communication channel 821. The media client 117 on the portable computing device 107 may use a transceiver 805 to request RM files from the media server 103 via a transceiver 801. The communications channel 819 between the transceiver 801 and the transceiver 805 has a sufficiently high bandwidth for transmitting RM files in an efficient manner while the communications channel 821 has sufficiently high bandwidth for transmitting EM files efficiently. The portable computing device's transceivers 803, 805 may represent a single device in some embodiments, and likewise the media server's associated transceivers 801, 113 may also represent a single device in some embodiments. Over time, bandwidth concerns may ease, such that a variety of communication channels could be used for dispensing both RM and EM files. The media server will still be configured to dispense separate RM and EM files, but the media servers may provide these files over one communication channel in some embodiments. In general, the media servers and the media clients may be adaptable to process EM and RM files through a variety of communications channels and may be further adapted to use whatever communications channels are available at the instant that EM and RM file requests are generated.

The communications channel 819 may operate according to any suitable wireless protocol. For example, the transceiver 801 may operate according to the BlueTooth protocol. Embodiments of the invention may include various intermediaries, kiosks and other platforms that provide RM files to portable computing devices such that the user (or the portable computing device's media client) only needs to locate a wireless source for EM files when the user wishes to play media files. For example, an embodiment of the invention may function as an automobile radio that receives RM files from a BlueTooth transceiver in a garage at night and wirelessly retrieves an appropriate EM file set during the day based on user selections.

Once the RM files 125 have been received and stored in a memory 807, then the media client 117 may turn off the transceiver 805. Turning off the transceiver 805 should reduce power consumption in the portable computing device 107. Of course, if the portable computing device 107 has an external power supply, then the media client 117 may have less need to conserve power. In addition, the transceiver 805 may need to be kept on for transmissions unrelated to media files.

The retrieval of RM files 125 may occur in an automatic mode, such that the portable computing device's user need not necessarily engage the RM file retrieval function each time the media client gathers new RM files. For example, a user associated with the portable computing device 107 may be traveling away from home. While at an airport lobby, the media client 117 uses the transceiver 805 to establish a high-bandwidth connection with the media server 103. The media server 103 may represent an RM file repository or an intermediary that itself receives periodic file updates from another media server, according to an embodiment of the invention.

At some point during the user's travels, the portable computing device's user chooses to play one or more of the media files that could be made available to his device. For example, the media client 117 may already have a number of RM files stored locally on the portable computing device. If no RM files are available locally, then the media client establishes a connection to a high bandwidth network in the manner described above. Once the RM files are available locally, and the user wishes to play the files, the media client uses the transceiver 803 to establish a wireless connection with the media server 103 via the transceiver device 113. The user may presently be located in a different city than the one in whose airport he received the RM file set, and the media server from which he is about the receive the corresponding EM file set may be a different media server than the one which provided the RM files. The media client 117 requests an appropriate set of EM files from the media server 103 via the connection established between the transceiver 803 and the transceiver 113.

Since the EM files typically have a significantly smaller size than the RM files, the channel 821 typically requires a lower bandwidth than the channel 819. The communication channel 821 established between the transceiver 803 and transceiver 113 may operate over a greater transmission range than the communication channel 819, according to embodiments of the invention. Returning to the airport example above, the user may move the portable computing device away from the transceiver 801 but still remain within range of the transceiver 113. For example, the transceiver 801 may operate only within a small portion of an airport terminal (e.g., by one of the departure gates). In contrast, the channel 821 established between the transceiver 113 and the transceiver 803 may represent a more pervasive wireless network, such as the wireless telephony network. Thus, the media client 117 may be able to obtain EM files so long as the portable computing device 107 is able to establish a connection within a wireless telephony network. Of course, the EM files may also be provided from a repository that itself receives periodic updates from another media server. Continuing with the airport example, the user may enter an aircraft that includes an EM file intermediary that dispenses EM files to the portable computing device 107 in a manner that does not interfere with the aircraft's electronics equipment.

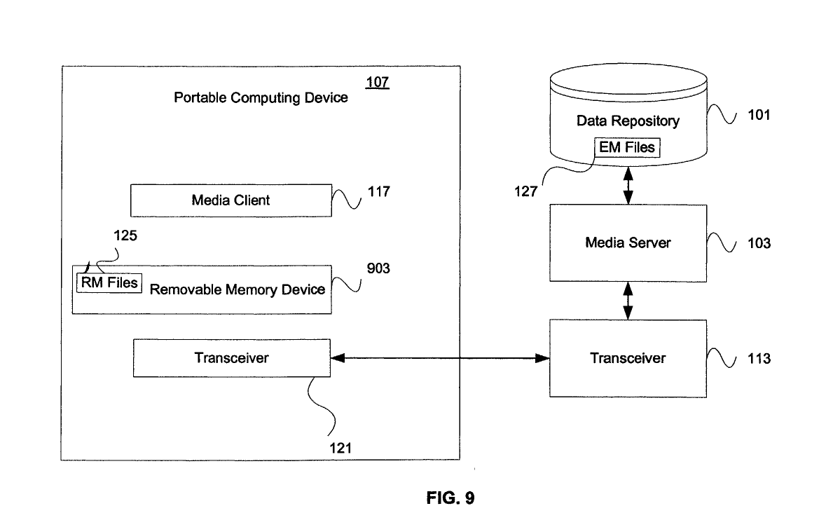

FIG. 9 is a diagram that illustrates a portable computing device 107 having a removable memory device 903 that contains RM files 125, according to an embodiment of the invention. In the embodiments previously discussed, the RM files 125 were transmitted to a portable computing device via some communications channel (e.g., synch cradle or wirelessly). In the embodiment illustrated in FIG. 9, the portable computing device 107 has become connected to a memory device 903 that contains RM files. For example, the removable memory device 903 could be a PMCIA card, a juke box memory device, or even a floppy disk that has been equipped with one or more RM files. The memory device 903 could be mailed, or even handed, to users associated with portable computing devices as promotional materials or on a subscription basis.

When engaged, the media client 117 surveys the set of available RM files on the portable computing device 107. The media client's survey allows it to determine not only what RM files are available but to also identify the EM files that should be requested from the media server 103. The media client 117 uses the transceiver 121 to establish a communications link with the transceiver 113 in the manner previously described. The media client 117 then asks the media server 103 for the set of EM files corresponding to the RM files in the memory device 903. The media server 103 may also require additional information (e.g., payment) before sending the EM files 127 to the portable computing device 107. The media client 117 may store the received EM files 127 in a memory and instruct the transceiver 121 to disconnect the connection with the transceiver 113. The memory that receives the EM files need not necessarily be the memory 903. The media client 117 may then reassemble and play the original media file in the manner previously described.

As discussed above, embodiments of the invention may employ a transceiver capable of sending RM files to portable computing devices, such as the transceiver 801 shown in FIG. 8. The portable computing devices may likewise have appropriate transmit-receive circuitry for establishing a data link with such transceivers. An ordinary artisan will recognize that a receiver and a transceiver could be used in place of, or in conjunction with, a transceiver. A suitable transceiver could comprise a short-range or medium-range radio frequency communications device, such as a BlueTooth enabled device. The Bluetooth communication protocol defines two power levels: a lower power level that can cover shorter communication ranges; and a higher power level that can cover medium communication ranges. Embodiments of the invention may utilize either or a combination of the two power levels depending on the desired communication range between a media server and a portable computing device. The transceiver may also operate as an 802.11 device that provides 1 or 2 Mbps transmissions in the 2.4 GHz band using either frequency hopping modulation (“FHSS”) or direct sequence spread spectrum (“DSSS”). The transceiver may be a third generation (“3G”) wireless device, as defined by the ITU under the IMT-2000 global framework. The transceiver could also operate using Code Division Multiple Access (“CDMA”), a method for transmitting simultaneous signals over a shared portion of the spectrum. Similarly, the transceiver could operate according to the Universal Serial Bus (“USB”) hardware interface for low-speed peripherals such as the keyboard, mouse, joystick, scanner, printer and telephony devices. Likewise, the transceiver could operate on FM subcarrier systems, and/or as a Time Division Multiple Access (“TDMA”) compliant device, and/or as a Global System for Mobile Communications (“GSM”) compliant device. Transmissions according to a satellite communications protocol could also be used by the transceiver, as well as protocols such as a Local Multipoint Distribution Service (“LMDS”) and/or Multichannel Multipoint Distribution Service (“MMDS”). The transceiver could also operate according to the MobileStar broadband wireless Internet access protocol, and a suitable transceiver could be a Wireless Ethernet Compatibility Association (“Wifi”) certified device.

Embodiments of the invention may further include a help system, including a wizard that directs a user through the steps of obtaining RM and EM files and/or selecting settings for the media client that may enable the media client to periodically attempt to retrieve RM files.

Software implementing the media client and client module may be written for operation with any computer operating system and for operation in any computing environment. In addition, any such software may be designed using CORBA, ACTIVEX® controls, JavaScript, and/or Java applets. According to one embodiment of the invention, Java applets may provide a plug-in media client for use with another application on the portable computing device.

The media client module and the client module may be built using an object-oriented programming methodology or using any other programming methodology that results in a computing system having appropriate functionality. The invention has been discussed in terms of computer programs but is equally applicable for systems utilizing hardware that performs similar functions, such as application specific integrated circuits (“ASICs”).

These and other changes can be made to the invention in light of the above detailed description. In general, in the following claims, the terms used should not be construed to limit the invention to the specific embodiments disclosed in the specification and the claims, but should be construed to include all systems and methods that operate under the claims set forth hereinbelow. Accordingly, the invention is not limited by the disclosure.

What is claimed is:

1. A method for playing a media file in a portable computing device, comprising:
receiving a first file portion in the portable computing device via a first communication channel, wherein the first file portion is unusable as a media file;
receiving a second file portion in the portable computing device via a second communication channel, wherein the second file portion is unusable as a media file; and
creating the media file in the portable computing device from the first file portion and the second file portion.

2. The method of claim 1 wherein receiving a second file portion in the portable computing device via a second communication channel further comprises:
connecting a wireless transceiver on the portable computing device to the second communication channel to receive the second media file, wherein the second communication channel is a wireless communication channel; and
disconnecting the transceiver on the portable computing device from the second communication channel once the second file portion has been received.

3. The method of claim 1, further comprising:
playing the media file on the portable computing device; and
deleting the media file once it has been played.

4. The method of claim 1 wherein the first communication channel is a connection between the portable computing device and a client computer, further comprising:
receiving the first file portion in the portable computing device from the client computer; and
storing the first file portion on the portable computing device.

5. The method of claim 4 wherein the connection is provided by at least one of a docking station or a synch cradle associated with the client computer and the portable computing device.

6. The method of claim 1 wherein the first communication channel is a wireless connection between a transceiver on the portable computing device and a transceiver associated with a media file repository, the method further comprising:
transmitting to the media file repository a request for transfer of the first file portion; and
terminating the first communication channel once the first file portion has been received on the portable computing device.

7. The method of claim 1 wherein creating the media file comprises:
examining sequencing information in the second file portion that describes where elements of the second media file should be placed within the first file portion to create the media file.

8. The method of claim 7, further comprising:
decrypting the first file portion using a key obtained from the second file portion.

9. A method for preparing media data for transmission to a portable computing device, comprising:
creating a first file portion by removing elements from a media file; and
creating a second file portion from the elements removed from the media file.

10. The method of claim 9, further comprising:
placing sequencing information in the second file portion that provides information on where the elements removed from the media file should be placed in the first file portion to reproduce the media file.

11. The method of claim 10, further comprising:
encrypting the first file portion using a key; and
placing the key in the second file portion.

12. The method of claim 9, further comprising:
transmitting the first file portion to a client computer configured to transmit the first file portion to the portable computing device.

13. The method of claim 9, further comprising:
storing the first file portion in a first data repository accessible to the portable computing device via a first communication channel; and
storing the second file portion in a second data repository accessible to the portable computing device via a second communication channel.

14. The method of claim 13 wherein the second data repository is included within the first data repository.

15. A portable computing device comprising:
a media client configured to request a first file portion from a client computing device and configured to assemble a media file using the first file portion and a second file portion, wherein the first and second file portions are unusable as media files; and
a first transceiver configured to receive the second file portion over a wireless communication channel.

16. The portable computing device of claim 15 wherein the media client is further configured to disconnect the transceiver from the wireless communication channel once the second file portion has been received.

17. The portable computing device of claim 15 wherein the media client is further configured to play the media file and delete the media file from the portable computing device once it has been played.

18. The portable computing device of claim 15 wherein the media client is further configured to examine sequencing information in the second file portion that describes where elements of the second media file should be placed within the first file portion to assemble the media file.

19. The portable computing device of claim 15 wherein the media client is further configured to decrypt the first file portion using a key obtained from the second file portion.

20. The portable computing device of claim 15 wherein media client is further configured to receive the first file portion from the client computer and store the first file portion in a memory on the portable computing device.

21. The portable computing device of claim 15 wherein the media client is further configured to request the first file portion from a data repository over a wireless communication channel, the device further comprising:
a second transceiver configured to receive the first file portion over the wireless communication channel.

22. The portable computing device of claim 21 wherein the media client is further configured to terminate the transceiver's connection to the wireless communication channel following reception of the first file portion.

23. The portable computing device of claim 15, further comprising a memory for storing the first file portion.

24. The portable computing device of claim 23 wherein the memory is configured to be removable from the portable computing device.

25. The portable computing device of claim 23 wherein the memory is further configured to store the second file portion.

26. A media playback device, comprising:
a first reception means for receiving a first file portion over a first communications channel, wherein the first file portion is unusable as a media file;
a second reception means for receiving a second file portion over a second communications channel, wherein the second file portion is unusable as a media file; and
a media assembly means for assembling a media file from the first file portion and the second file portion.

27. The media playback device of claim 26 wherein the second communications channel is a wireless communications channel, the device further comprising:
a power saving means configured to disconnect the second reception means from the second communications channel once the second file portion has been received.

28. The media playback device of claim 26, further comprising:
a playback means for playing the media file.

29. The media playback device of claim 28 wherein the playback means is further configured to delete the media file as it is played.

30. The media playback device of claim 26 wherein the media assembly means is configured to assemble the media file using sequencing instructions in the second file portion.

31. The media playback device of claim 30 wherein the sequencing instructions describe where to find information in the second file portion that should be placed in the first file portion to assemble the media file, the media playback device further configured to locate the information and place the information in the first file portion.

32. A media server for transmitting media data to a portable computing device, comprising:
means for creating a first file portion by removing elements from a media file, wherein the first file portion is unusable as a media file; and
means for creating a second file portion from the elements removed from the media file, wherein the second file portion is unusable as a media file.

33. The media server of claim 32, further comprising:
means for placing sequencing information in the second file portion that provides information on where the elements removed from the media file should be placed in the first file portion to reproduce the media file.

34. The media server of claim 33, further comprising:
means for encrypting the first file portion using a key; and
means for placing the key in the second file portion.

35. The media server of claim 32, further comprising:
means for transmitting the first file portion to a client computer configured to transmit the first file portion to the portable computing device.

36. The media server of claim 32, further comprising:
a transceiver configured to transmit the second file portion to the portable computing device.

37. The media server of claim 32, further comprising:
means for storing the first file portion in a first data repository accessible to the portable computing device via a first communication channel; and
means for storing the second file portion in a second data repository accessible to the portable computing device via a second communication channel.

38. The media server of claim 37 wherein the second data repository is included within the first data repository.

39. A media client for processing media files on a portable computing device, comprising:
a first file manager configured to request a first file portion over a first communications channel, wherein the first file portion is unusable as a media file;
a second file manager configured to request a second file portion over a second communications channel, wherein the second file portion is unusable as a media file; and
a media file reconstructor configured to reconstruct a media file from the first file portion and the second file portion.

40. The media client of claim 39, further comprising:
a media file player configured to perform the media file reconstructed by the media file reconstructor.

41. The media client of claim 40 wherein the media file reconstructor is further configured to reconstruct the media file in media file sections and provide each reconstructed media file section to the media file player and wherein the media file player is further configured to delete media file sections once they are played.

42. The media client of claim 39, further comprising:
a transceiver controller configured to instruct a transceiver to disconnect from the second communications channel upon receipt of the second file portion.

43. The media client of claim 39 wherein the media file reconstructor is further configured to examine the second file portion to locate sequencing data and wherein the media file reconstructor is further configured to use the sequencing data to locate data in from the second file portion and add the data to the first file portion to reconstruct the media file.

44. The media client of claim 39 wherein the media file reconstructor is further configured to examine the second file portion to locate a key and wherein the media file reconstructor is further configured to use the key to decrypt the first file portion to obtain the media file.

45. The media client of claim 39 wherein the first communications channel is a connection between the portable computing device and a client computer and wherein the first file manager is further configured to send a request over the first communications channel requesting transmission of the first file portion.

46. The media client of claim 39 wherein the first communications channel is a wireless connection between the portable computing device and a media server and wherein the first file manager is further configured to send a request over the first communications channel requesting transmission of the first file portion.

47. The media client of claim 39 wherein the first communications channel is a wireless connection between the portable computing device and another portable computing device and wherein the first file manager is further configured to send a request over the first communications channel requesting transmission of the first file portion.

48. The media client of claim 39 wherein first file manager is further configured to store the first file portion in a memory on the portable computing device.

49. The media client of claim 39 wherein the first file manager is further configured to examine a memory on the portable computing device for at least one first file portion upon receipt of a request for at least one media file.

50. The media client of claim 39 wherein the second communications channel is a wireless connection between the portable computing device and a media server and wherein the second file manger is further configured to send a request over the second communications channel requesting transmission of the second file portion.

51. A computer program product for use in connection with a portable computing device to provide media data for execution by a media client associated with the portable computing device, the portable computing device including a memory configured to store the computer program product, the computer program product comprising:
a first file portion rendered unusable as media data by removal of a plurality of data elements; and
a second file portion containing the plurality of data elements removed from the first file portion and sequencing information that explains where the plurality of data elements removed should be placed in the first file portion to produce a media file.

52. The computer program product of claim 51 wherein the first file portion has been encrypted and wherein the second file portion further contains a key that may be used to decrypt the first file portion.

53. A computer-readable medium containing instructions for controlling a portable computing device to play a media file when executing the instructions, the computer-readable medium instructions comprising:
receiving a first file portion in the portable computing device via a first communication channel, wherein the first file portion is unusable as a media file;
receiving a second file portion in the portable computing device via a second communication channel, wherein the second file portion is unusable as a media file; and
creating the media file in the portable computing device from the first file portion and the second file portion.

54. The computer-readable medium of claim 53 wherein instructions for receiving a second file portion in the portable computing device via a second communication channel further comprise:
connecting a wireless transceiver on the portable computing device to the second communication channel to receive the second media file, wherein the second communication channel is a wireless communication channel; and
disconnecting the transceiver on the portable computing device from the second communication channel once the second file portion has been received.

55. The computer-readable medium of claim 53, the instructions further comprising:
playing the media file on the portable computing device; and
deleting the media file once it has been played.

56. The computer-readable medium of claim 53 wherein the first communication channel is a connection between the portable computing device and a client computer, the instructions further comprising:
receiving the first file portion in the portable computing device from the client computer; and
storing the first file portion on the portable computing device.

57. The computer-readable medium of claim 56 wherein the connection is provided by at least one of a docking station or a synch cradle associated with the client computer and the portable computing device.

58. The computer-readable medium of claim 53 wherein the first communication channel is a wireless connection between a transceiver on the portable computing device and a transceiver associated with a media file repository, the instructions further comprising:
transmitting to the media file repository a request for transfer of the first file portion; and
terminating the first communication channel once the first file portion has been received on the portable computing device.

59. The computer-readable medium of claim 53 wherein instructions for creating the media file further comprise:
examining sequencing information in the second file portion that describes where elements of the second media file should be placed within the first file portion to create the media file.

60. The computer-readable medium of claim 59, the instructions further comprising:
decrypting the first file portion using a key obtained from the second file portion.
